(19) United States
(12) Patent Application Publication
(10) Pub. No.: US 2024/0285088 A1
(43) Pub. Date: Aug. 29, 2024

(54) CUSHIONING MEMBER SYSTEMS AND ASSEMBLIES

(71) Applicants: Kevin M. TAR, Trinity, NC (US); Micah A. KAUFMAN, Trinity, NC (US); Stephen WALLACE, Trinity, NC (US); Anthony G. TUROSO, Trinity, NC (US); Gary P. FORD, Trinity, NC (US); SEALY TECHNOLOGY LLC, Trinity, NC (US)

(72) Inventors: Kevin M. Tar, Summerfield, NC (US); Micah A. Kaufman, Lexington, KY (US); Stephen Wallace, Duffield, VA (US); Anthony G. Turoso, Lexington, KY (US); Gary P. Ford, Lexington, KY (US)

(21) Appl. No.: 18/574,519

(22) PCT Filed: Jul. 5, 2022
(86) PCT No.: PCT/US2022/073411

§ 371 Date: Dec. 27, 2023

Related U.S. Application Data
(60) Provisional application No. 63/218,166, filed on Jul. 2, 2021.
(60) Provisional application No. 63/218,171, filed on Jul. 2, 2021.
(60) Provisional application No. 63/218,238, filed on Jul. 2, 2021.
(60) Provisional application No. 63/218,239, filed on Jul. 2, 2021.
(60) Provisional application No. 63/218,241, filed on Jul. 2, 2021.
(60) Provisional application No. 63/218,242, filed on Jul. 2, 2021.

(51) Int. Cl. A47C 23/00; A47C 27/06; A47C 27/15

(52) U.S. Cl. CPC A47C 23/002; A47C 27/062; A47C 27/065; A47C 27/15

(57) ABSTRACT

A cushioning system may include a plurality of cushioning members comprising an elastomeric material. Each cushioning member may comprise a top end, bottom end, and a plurality of walls extending from the top end to the bottom end and defining a plurality of cavities. Each cushioning member may be substantially planar with a mating profile configured to engage with a complimentary mating profile of a second cushioning member. A mattress assembly may include a cushioning system as a support layer.

### CROSS-REFERENCE TO RELATED APPLICATIONS

The present application claims priority to and filing benefit of U.S. provisional patent application Ser. No. 63/218,242, filed Jul. 2, 2021, U.S. provisional patent application Ser. No. 63/218,166, filed Jul. 2, 2021, U.S. provisional patent application Ser. No. 63/218,171, filed Jul. 2, 2021, U.S. provisional patent application Ser. No. 63/218,238, filed Jul. 2, 2021, U.S. provisional patent application Ser. No. 63/218,239, filed Jul. 2, 2021, and U.S. provisional patent application Ser. No. 63/218,241, filed Jul. 2, 2021, each of which is incorporated herein by reference in its entirety.

### FIELD

This application relates to cushioning members and products incorporating such cushioning members, and, more particularly, to systems including cushioning members having a plurality of cavities.

### BACKGROUND

Cushioning members may be used in a variety of applications, including but not limited to mattresses and packaging, and may be provided to minimize or reduce forces on an object or user. Cushioning members have traditionally been formed in a wide variety of configurations and with a wide variety of materials. However, such traditional cushioning members may offer only limited cushioning, may be difficult to manufacture, may be expensive to produce from a material perspective and a labor perspective, and/or provide insufficient support, among other issues. Some traditional cushioning members may provide support and stability when static forces are applied, but may exhibit limited stability when dynamic forces are applied, especially lateral forces.

### SUMMARY

Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain examples, a cushioning member may include a top end, a bottom end, and a plurality of walls extending from the top end to the bottom end. The plurality of walls may define a plurality of cavities. In some examples, the plurality of walls may include an elastomeric material. In various examples, between the top end and the bottom end, each wall may include at least a first compression region and a second compression region.

According to certain examples, a system may comprise a plurality of cushioning members comprising an elastomeric material, where each wall comprises at least a first compression region and a second compression region. Each cushioning member may be substantially planar and have a mating profile configured to engage with a complimentary mating profile of another cushioning member. The mating profile may comprise projections and recesses configured to interlock with projections and recesses of another cushioning member to form a cushioning grid. Cushioning members may be interlocked in a co-planar arrangement to form a cushioning grid.

The system may optionally be used or otherwise incorporated into a plurality of assemblies or products. In some non-limiting examples, a mattress assembly having a support structure may optionally include the cushioning system described herein as a support layer. According to certain examples, a mattress assembly may comprise a system of cushioning members comprising an elastomeric material, one or more layers of foam, and optionally, a coil layer. A base layer of foam or other material may be used to support the mattress assembly.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a perspective view of an assembly including a support structure and cushioning members according to various embodiments.

FIG. 2 is a perspective view of a portion of one of the cushioning members of FIG. 1.

FIG. 3 is a side view of a wall of a cushioning member according to various embodiments.

FIG. 4 is a side view of another wall of a cushioning member according to various embodiments.

FIG. 5 is a side view of another wall of a cushioning member according to various embodiments.

FIG. 6 is a side view of another wall of a cushioning member according to various embodiments.

FIG. 7 is a perspective view of an assembly of cushioning members according to various embodiments.

FIG. 8 is a top view of a portion of a cushioning member according to various embodiments.

FIGS. 9-13 are images of cushioning members according to various embodiments.

FIGS. 14 and 15 are a perspective views of complementary cushioning members interlocked to form a system according to various embodiments.

FIG. 16 is a perspective view of complementary cushioning members interlocked to form a system according to various embodiments.

FIG. 17 is a perspective view of complementary cushioning members having different properties interlocked to form a system according to various embodiments.

FIG. 18 is a schematic of an injection molding process.

FIG. 19 is an image of a molded cushioning member.

FIGS. 20 and 21 are images of an offset mold used for a cushioning member.

FIG. 22 is a perspective view of a cushioning member with backing material.

FIG. 23 is a perspective view of a base structure according to various embodiments.

FIG. 24 is a perspective view of a base structure housing complementary cushioning members according to various embodiments.

FIG. 25 is an expanded top view of a mattress assembly according to various embodiments.

FIG. 26 is a side view of a mattress assembly according to various embodiments.

FIG. 27 is an expanded top view of a mattress assembly comprising coils according to various embodiments.

FIG. 28 is a side view of a mattress assembly comprising coils according to various embodiments.

### DETAILED DESCRIPTION

The subject matter is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others are intended to refer to the orientation as illustrated and described in the figure (or figures) to which the components and directions are referencing but are not intended to imply any particular configuration.

Described herein are cushioning members having a plurality of elastomeric walls that form cavities having various shapes. When viewed from above, or in a plan view, the walls may optionally create repeating patterns.

In some examples, one or more walls of a particular cushioning member may have variable compression regions along a height of the wall. In certain examples, a stiffness profile or distribution of the cushioning member may be controlled by controlling one or more of a pattern of the cavities, a density of the walls, a wall thickness of each wall, a height of the walls, a height of the compression regions, a material of the compression regions, a draft angle of the compression regions, combinations thereof, or as otherwise desired. In addition, the cushioning members described herein may be modular and may be assembled with various other cushioning members as desired, which may have similar or different stiffness profiles or distributions, to create a cushioning assembly having a stiffness profile or distribution as desired. The cushioning members described herein may be used independently or with various systems or assemblies as desired, including but not limited to mattress assemblies. The cushioning members described herein may provide other benefits and advantages, and the aforementioned listing should not be considered limiting.

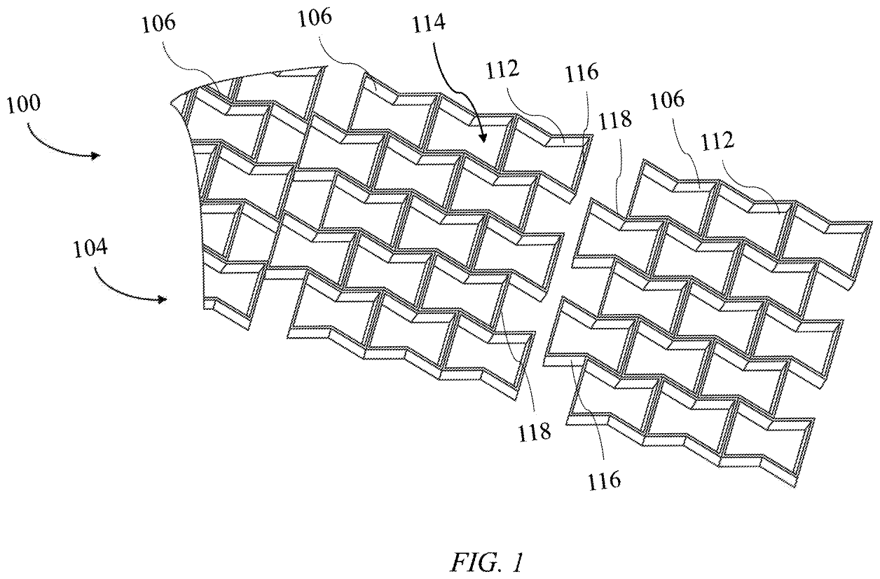

FIG. 1 illustrates a cushioning assembly 104 according to various embodiments. As illustrated in FIG. 1, the cushioning assembly 104 includes one or more cushioning members 106. Each cushioning member 106 may be constructed from various elastomeric materials as desired such that the cushioning member 106 is compressible as discussed in greater detail below. As some non-limiting examples, the elastomeric materials may include, but are not limited to, a styrenic block copolymer and an oil. Other suitable materials as desired may be included. In some embodiments, the elastomeric material forming the cushioning member 106 may optionally have a hardness of from 10 Shore 00 to 80 Shore 00, inclusive. The cushioning members 106 may be constructed from various processes as desired, including but not limited to injection molding. The cushioning assembly 104 may include any number of cushioning members 106 as desired, including one cushioning member 106 or a plurality of cushioning members 106.

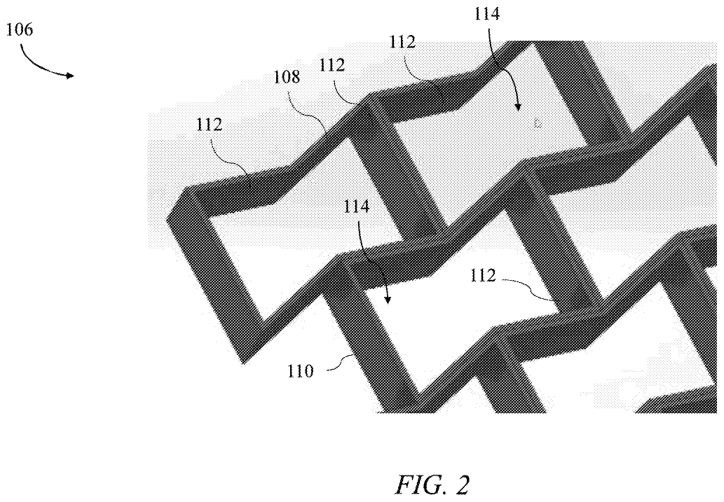

As illustrated in FIG. 2, each cushioning member 106 may include a top end 108, a bottom end 110, and a plurality of walls 112 defining a plurality of cavities 114. The distance from the top end 108 to the bottom end 110 is a height of the walls 112. In some embodiments, the height of the walls 112 may be from 0.5 inches to 5.0 inches, inclusive, although in other embodiments the walls 112 may have other heights as desired that may be less than 0.5 inches and/or greater than 5.0 inches. For example, the height of the walls may be 0.5 in, 0.75 in, 1 in, 1.25 in, 1.5 in, 1.75 in, 2 in, 2.25 in, 2.5 in, 2.75 in, 3 in, 3.25 in, 3.5 in, 3.75 in, 4 in, 4.25 in, 4.5 in, 4.75 in, or 5 in.

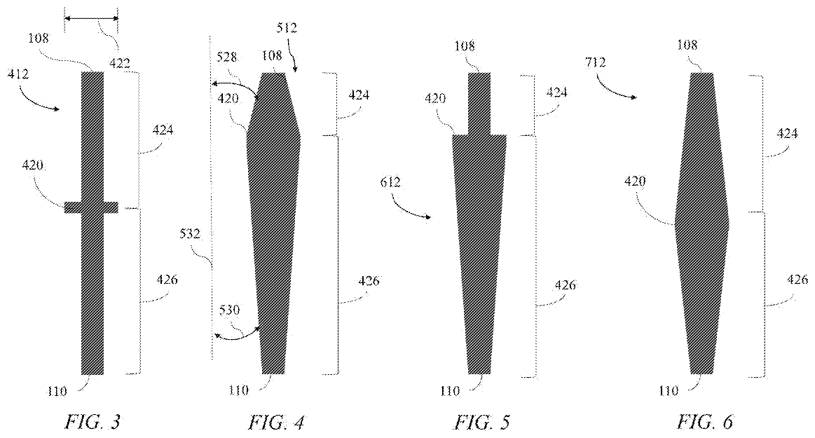

Between the top end 108 and the bottom end 110, each wall 112 may have at least a first compression region, and in some optional examples, one or more walls 112 may have a second compression region. As discussed in greater detail below with reference to FIGS. 3-7, a parting line on the wall may separate the first compression region from the second compression region. The response curve of the compression regions may be controlled by controlling one or more of a material used, a wall thickness of the particular region, a wall shape or geometry of the particular region, supplemental features included in a particular region (e.g., grooves, ribs, notches, etc.), combinations thereof, or other characteristics as desired. In various examples, the walls with at least two compression regions may be progressive springs when subjected to a compression force, either as a constantly increasing type of progressive spring or a dual (or more) type of progressive spring. In some examples, a height of the first compression region may be the same as the height of the second compression region, although it need not be in other examples. Moreover, within the cushioning member, the relative heights of the compression regions on one wall may be the same as or different from the compression regions on another wall. In certain examples, the heights of the first and second compression regions may be controlled such that the cushioning member has a desired stiffness distribution as desired.

Each wall may have a maximum wall thickness. In some embodiments, and as discussed in greater detail below, at least one wall of the plurality of walls may optionally have a non-uniform or variable wall thickness between the top end 108 and the bottom end 110. In certain examples, the maximum wall thickness of the walls may be from 0.1 inches to 0.25 inches, inclusive, although in other embodiments the maximum wall thickness may be less than 0.1 inches and/or greater than 0.25 inches. In some examples, the maximum wall thickness of each wall may be the same. However, in other examples, a maximum wall thickness of one of the walls may be different from a maximum wall thickness of another one of the walls. As some non-limiting examples, a wall forming a perimeter of the cushioning member 106 may have a maximum wall thickness that is less that a maximum wall thickness of an interior wall of the cushioning member 106.

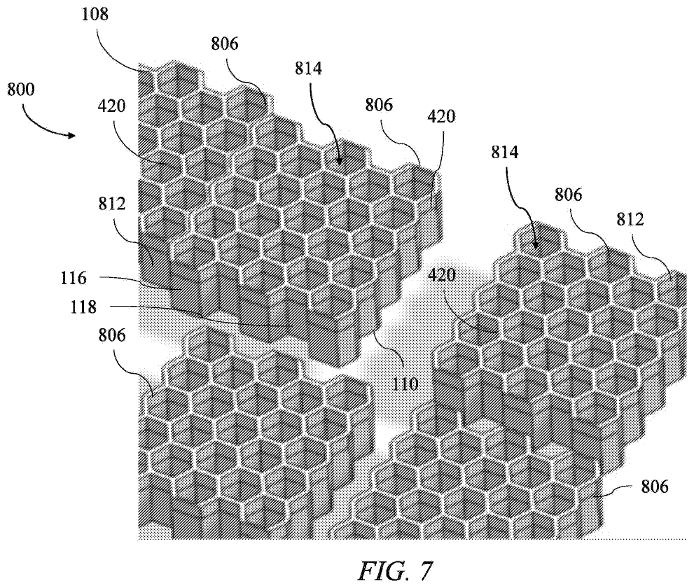

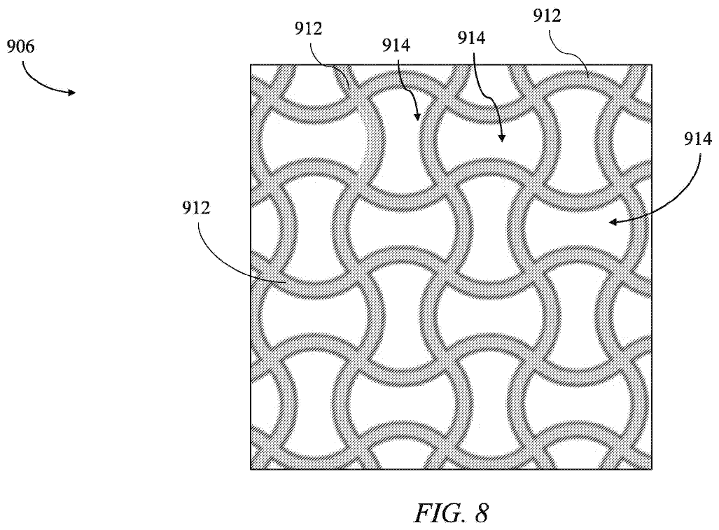

In the example of FIGS. 1 and 2, the plurality of walls, 112 define cavities 114 that are bowtie shaped; however, in other embodiments, the walls 112 may define cavities 114 having other shapes as desired. As one non-limiting example, FIG. 7 illustrates an example of cushioning members 806 with cavities 814 that are hexagon shaped. As a further example, FIG. 8 illustrates an example of a cushioning member 906 with cavities 914 that are auxetic. Moreover, while the cavities 114 in the example of FIGS. 1 and 2 all have the same shape, they need not in other examples. As a non-limiting example, a cushioning member may have at least one cavity that is a first shape (e.g., bowtie shaped like FIGS. 1 and 2) and at least one cavity that is a second shape (e.g., rectangular or otherwise as desired).

In some examples, the size and shape of the cavities formed by the walls may be controlled such that the pattern of cavities in the cushioning member has a desired density, which may impact the support provided by the cushioning member. As a non-limiting example, the size and shape of the cavities may be adjusted to increase the density and provide more support or decrease the density to provide less support.

In various examples, and as illustrated in FIG. 1, at least some of the perimeter walls 112 may optionally define a first mating profile 116 and at least some of the perimeter walls 112 may optionally define a second mating profile 118 that may be complimentary to the first mating profile 116. In various embodiments, the mating profiles 116, 118 may interlock or otherwise connect with mating profiles 116, 118 of another cushioning member 106 to form the cushioning assembly 104 having a plurality of cushioning members 106.

FIG. 3 illustrates another example of a wall 412 for a cushioning member. The wall 412 is substantially similar to the walls illustrated in the example of FIGS. 1 and 2 except that the wall 412 includes a parting line 420 between the top end 108 and the bottom end 110. In some examples, a thickness 422 at the parting line 420 of the wall 412 may be the maximum wall thickness, although it need not be in other examples. A parting line reflects where the halves of the injection mold meet when the mold is closed. The line indicates the parting “plane” that passes through the part. As illustrated in FIG. 3, the wall 412 optionally may have a constant wall thickness between the parting line 420 and the bottom end 110.

In the example of FIG. 3, a first compression region 424 is defined between the parting line 420 and the top end 108, and a second compression region 426 is defined between the parting line 420 and the bottom end 110. In the example of FIG. 3, the parting line 420 is illustrated as halfway between the top end 108 and the bottom end 110, or at a location that is 50% of the wall height with 0% being at the bottom end 110 and 100% being at the top end 108. In other examples, the location of the parting line 420 between the top end 108 and the bottom end 110 may be adjusted to adjust the heights of the compression regions 424, 426 as desired. In some non-limiting examples, the parting line 420 may optionally be provided at a location that may be between 5% and 95%, inclusive, of the wall height, such as between 25% and 75%, inclusive, of the wall height. For example, the parting line may be 5%, 10%, 15%, 20%, 25%, 30%, 35%, 40%, 45%, 50%, 55%, 60%, 65%, 70%, 75%, 80%, 85%, 90%, or 95% of the wall height. In examples where the plurality of walls of the cushioning member include the parting line 420, the parting line 420 may be at the same location on all of the walls, or the parting line 420 on one wall may be at a first location and the parting line 420 on another wall may be at a second location different from the first location. Moreover, in other examples, all of the walls of the cushioning member need not include the parting line 420.

FIG. 4 illustrates another example of a wall 512 for a cushioning member. The wall 512 is substantially similar to the wall 412 and includes the parting line 420. However, compared to the wall 412 where the parting line 420 was at location that is 50% the height of the wall 412, the parting line 420 of the wall 512 is at a location that is 75% the height of the wall 512 (i.e., it is closer to the top end 108 than the bottom end 110). As such, compared to the wall 412, the height of the first compression region 424 of the wall 512 is different from (e.g., less than) the height of the second compression region 426.

In addition, compared to the wall 412, the first compression region 424 of the wall 512 may extend at a first draft angle 528 and the second compression region 426 of the wall 512 may extend at a second draft angle 530 relative to a vertical axis 532 (which may be the vertical axis of a particular cavity of the cushioning member). The first draft angle 528 may be different from the second draft angle 530, although it need not be in other embodiments. In certain examples, the draft angles 528, 530 may be from greater than 0° to 50°, such as from 10° to 30°, such as from 20° to 25°, such as from 1° to 3°, and/or any sub-range of angles as desired. In other embodiments, the draft angles 528, 530 may be greater than 50°.

FIG. 5 illustrates another example of a wall 612 for a cushioning member. The wall 612 is substantially similar to the wall 512 except that the first compression region 424 has a constant wall thickness. FIG. 6 illustrates another example of a wall 712 for a cushioning member. The wall 712 is substantially similar to the wall 412 except that like the wall 512, both the first compression region 424 and the second compression region 426 extend at the draft angles.

It will be appreciated that while FIGS. 3-6 illustrate walls for cushioning members that are vertically symmetrical, in other examples the walls need not be vertically symmetrical. Moreover, within a cushioning member having a plurality of walls, the profiles of the walls may be identical or different as desired. As a non-limiting example, a cushioning member may include a plurality of walls that are all the walls 512. As another non-limiting example, a cushioning member may include a plurality of walls where some of the walls are the walls 412 and other walls are the walls 612. As a further non-limiting example, a cushioning member may include a plurality of walls where some of the walls are the walls 412 and others of the walls are similar to the walls 412 except that the parting line 420 is at a location that is 25% of the wall height.

FIG. 7 illustrates an example of a cushioning assembly 804. The cushioning assembly 804 is similar to the cushioning assembly 104 and includes a plurality of cushioning member 806. The cushioning members 806 are substantially similar to the cushioning members 106 except that the walls 812 of the cushioning members 806 include the parting line 420 at a location that is 75% of the wall height, and the walls 812 form cavities 814 that are hexagon shaped. The parting line may be located at a uniform position on the molded part. In some examples, the parting line may be located at varying percentages of the wall height. For example, the parting line location may vary for parts produced in an offset mold.

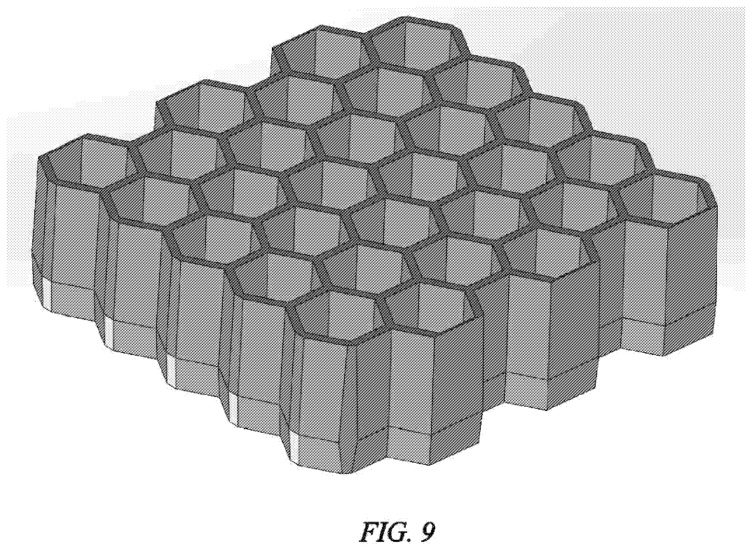

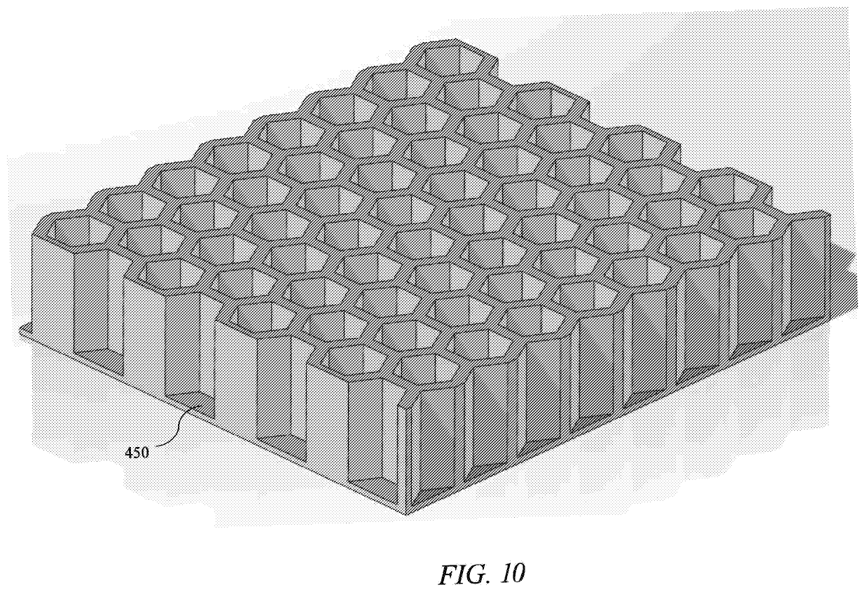

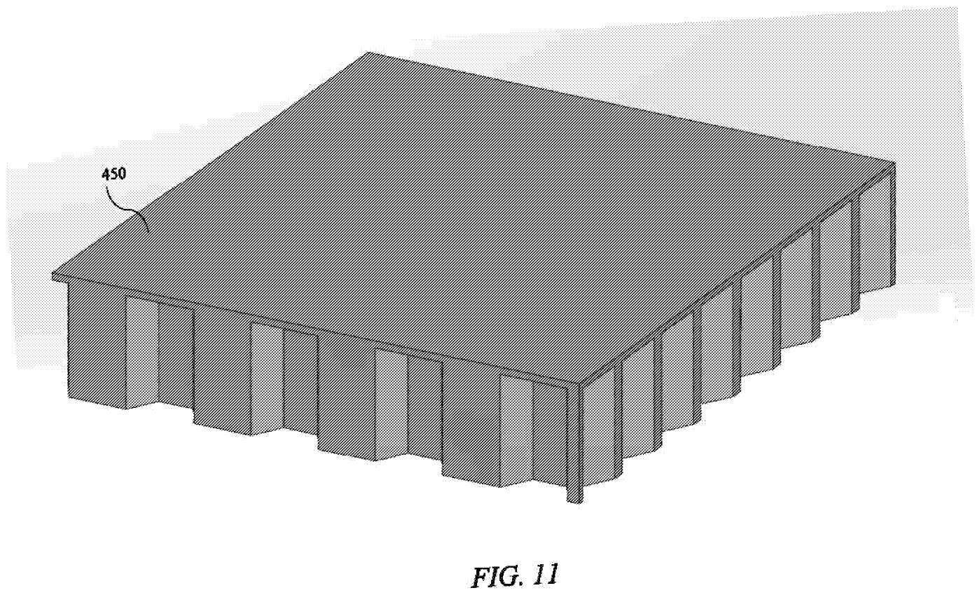

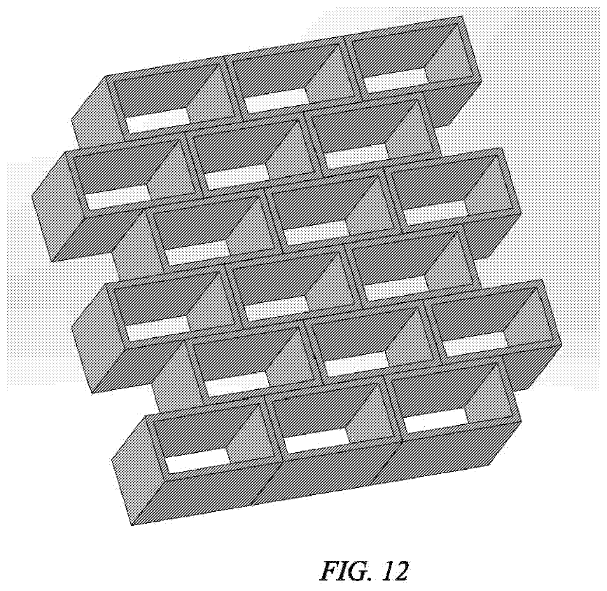

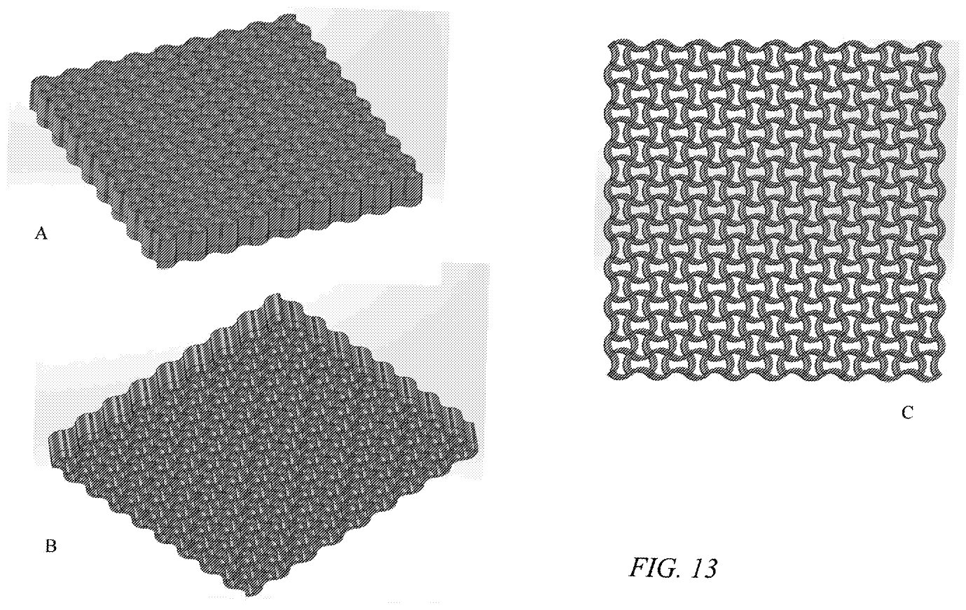

FIG. 8 illustrates an example of a cushioning member 906. The cushioning member 906 is substantially similar to the cushioning member 106 except that the walls 912 of the cushioning member 906 form cavities 914 that are auxetic. FIGS. 9-13 illustrate further examples of a cushioning member. In some examples, the cushioning member may include a floor 450 forming a closed cavity, as shown in FIGS. 10 and 11.

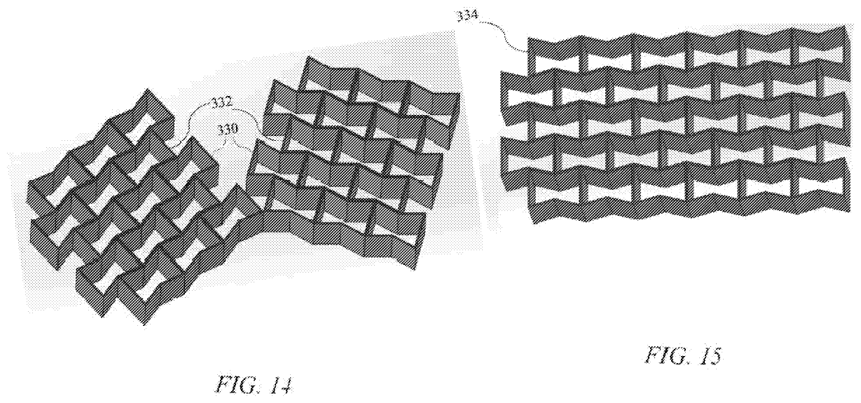

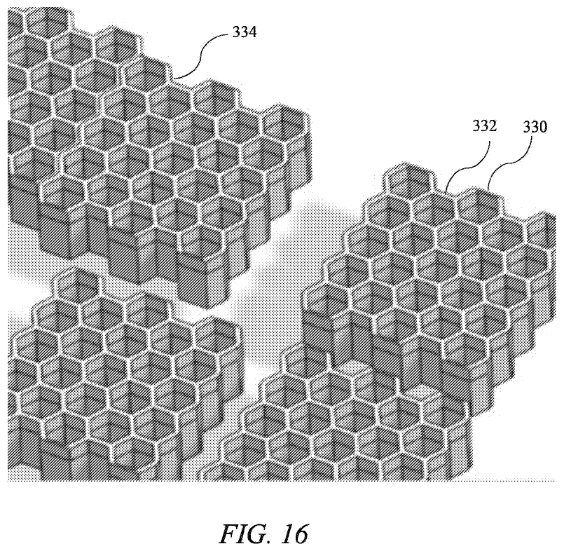

Each cushioning member may be substantially planar and the mating profile may be configured to engage with a complimentary mating profile of another cushioning member. As shown in FIGS. 14-16, the mating profile may comprise projections 330 and recesses 332 configured to interlock with projections and recesses of another cushioning member to form a cushioning grid 334. In various examples, at least some of the perimeter walls may optionally define a first mating profile and at least some of the perimeter walls may optionally define a second mating profile that is complimentary to the first mating profile. In various examples, the mating profiles may interlock or otherwise connect with mating profiles of another cushioning member to form a system comprising a plurality of cushioning members.

In some examples, the cushioning members of the systems described herein may be connected to one another using an adhesive, thermal bond, mechanical connection, or other means known to those skilled in the art. The connection of the members may be permanent or may be semi-permanent to allow for repositioning or changing out of members to adjust the properties of the system. In some examples, the cushioning members of the systems described herein may be connected to a substrate using an adhesive, thermal bond, mechanical connection, or other means known to those skilled in the art.

In some examples, a stiffness profile or distribution of the cushioning member may be modified by adjusting one or more of a pattern of the cavities, a density of the walls, a wall thickness of each wall, a height of the walls, a height of the compression regions, a material of the compression regions, a draft angle of the compression regions, combinations thereof, or as otherwise desired. In some examples, the composition of the elastomeric material may be adjusted to modify the amount of support provided by the cushioning member. Cushioning members of the same size and density may provide different support levels, e.g., have a different strength or hardness, based on the additives included in the composition.

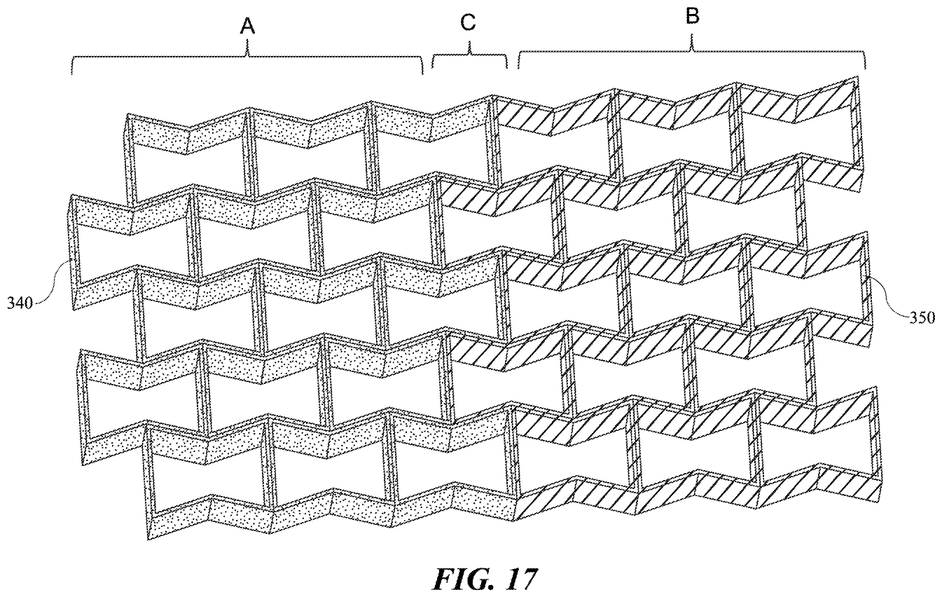

In addition, the cushioning members described herein may be modular and may be assembled with various other cushioning members as desired, which may have similar or different property profiles or distributions, to create a cushioning assembly having a profile or distribution of the property as desired, e.g., hardness, stiffness, or strength. As a non-limiting example, a cushioning member having an increased stiffness may be assembled with a cushioning member having a decreased stiffness to provide a desired stiffness distribution on the cushioning assembly system. FIG. 17 shows one example of a system that includes cushioning members having different properties, member A (340) is firm and member B (350) is soft. By interlocking cushioning members 340 and 350 with different properties, a gradient or blended area C can be created at the intersection of the members and an abrupt transition can be avoided.

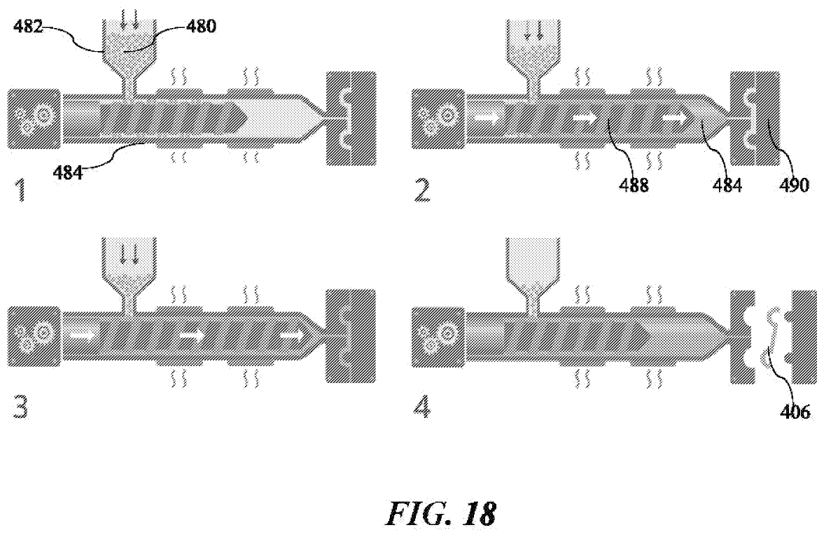

The cushioning members described herein may be produced using an injection molding process. An injection molding cycle can be used to create hundreds or thousands of parts in a relatively short amount of time. A schematic of an injection molding process is shown in FIG. 18. In a typical process, thermoplastic material 480, often in granular or pelletized form, can be fed through a hopper 482 into a heating barrel 484. The material can be heated to form a molten mixture 486 that can be driven by a screw 488 through one or more gates into a mold 490. Once the mold 490 has been filled, the screw 488 can remain in place to apply a determined amount of pressure for a determined amount of time to allow for the molded part to cool. Once sufficiently cool, the screw 488 may withdraw, the mold 490 open, and the part 406 may be ejected. Optionally, the part 406 may be ejected with the aid of ejector pins (not shown). The runner portion of the part formed from the gate path may shear off automatically, remain, or may be manually removed.

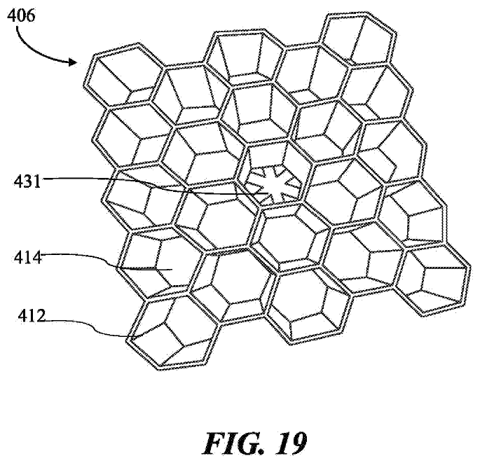

The mold may comprise two parts, a cavity mold and a core mold. The molded part, including runner and sprue, may be ejected with the aid of ejector pins. FIG. 19 shows a cushioning member 406 produced by an injection molding process. The cushioning member 406 includes a plurality of walls 412 defining a plurality of cavities 414 and runner 431.

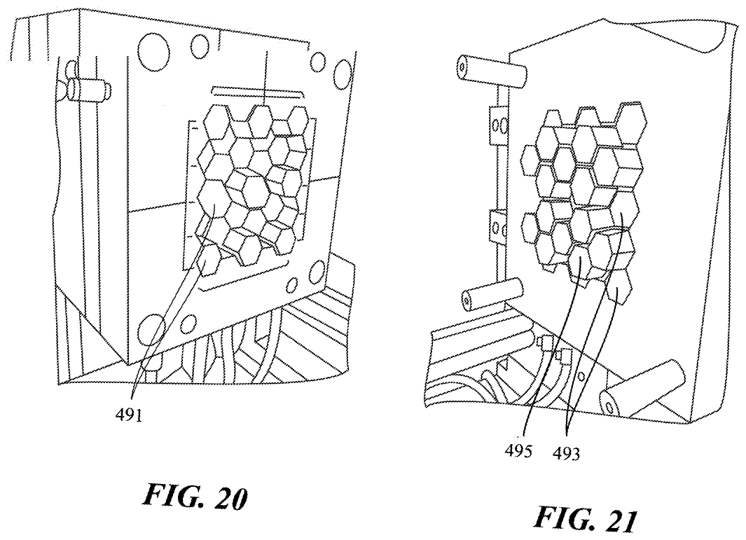

For a rigid part, ejector pins can push the cooled part off the mold and into a collection area to free the mold for the next injection cycle. For soft materials, such as an elastomeric material with a hardness of less than 80 Shore 00, ejector pins may sink into the material and fail to exert sufficient force to eject the part from the mold. In some cases, soft elastomeric material parts such as cushioning member may have to be manually removed from a mold by an operator. To assist with removal, the mold may be modified as shown in FIGS. 20 and 21. A portion of the mold protrusions may be placed on each side of the mold, which in turn places a portion of the mold cavity on both sides of the mold. The protrusions may be staggered across the face of the mold. This offset configuration can provide for the molded part to be removed from at least a portion of the cavity without the use of ejector pins and without exerting excessive forces, which may tear or damage soft elastomeric materials. For example, as shown in FIG. 20, a series of hex protrusions 491 may be arranged at the top, middle, and bottom of part 1 of the mold. In this particular arrangement, the protrusions may be flush with the mold face. Complementary arrangements are shown in FIG. 21, with the top, middle, and bottom hexes 493 being designed to mate with the hexes 491 of FIG. 20 while other hex protrusions 495 may extend beyond the face, and into complementary cavities as shown in FIG. 20. While the mold shown in FIGS. 20 and 21 is for hexagonal cavities, other cavity shapes may be contemplated, including but not limited to, square grid, rectangular grid, rectangular running bond, bowtie, auxetic, circular, among others.

Conventional polymeric materials used in injection molding have a hardness above 80 or 100 Shore 00, and more typically have a hardness measured on a Shore A or Shore D scale. Manufacturers may utilize low pressure or atmospheric processes such as screed molding or other horizontal molding configuration that allow for gravity or low pressure filling for materials having a hardness of less than 80 Shore 00 and/or a low viscosity. For materials with a hardness of less than 80 Shore 00 and/or a low viscosity compared to conventional polymeric materials, processing by injection molding at elevated pressures and in a vertical mold can be difficult. The material may not have bulk properties conducive to injection molding under pressure or other vertical molding processes and optimization of the process and bulk properties of the material may be needed.

The temperature for injection molding the polymeric materials described herein may range from about 215° C. to about 270° C. The barrel temperature may increase in two or more zones along the length of the barrel from the hopper to the mold. For example, a feed zone may have a lower temperature than a screw zone. The mold may be temperature controlled. The mold may include a hot runner system. The temperature of the material in the hot runner system may be greater than the temperature of the material within the barrel. In some cases, the temperature of the mold may be from about 60° F. to about 100° F. Back Pressure may be up to about 50 psi. In some cases, back pressure may be up to 85 psi. Cycle times may range from about 15 seconds to about 120 seconds.

In some examples, the molded elastomeric cushioning member may be substantially square, with the same length and width. In some examples, the molded elastomeric cushioning member may be substantially rectangular, with a length longer than a width of the part. In some examples, the molded elastomeric cushioning member may be about 6 in×6 in, about 20 in×24 in, or other sizes in between. The molded elastomeric cushioning member may have a depth of about 1 inch to 5 inches. For example, the molded elastomeric cushioning member may have a length of about 6 in, 7 in, 8 in, 9 in, 10 in, 11 in, 12 in, 13 in, 14 in, 15 in, 16 in, 17 in, 18 in, 19 in, 20 in, 21 in, 22 in, 23 in, or 24 in. For example, the molded elastomeric cushioning member may have a width of about 6 in, 7 in, 8 in, 9 in, 10 in, 11 in, 12 in, 13 in, 14 in, 15 in, 16 in, 17 in, 18 in, 19 in, 20 in, 21 in, 22 in, 23 in, or 24 in. Other dimensions and depths are envisioned.

A cushioning member may be constructed from various elastomeric materials as desired such that the cushioning member is compressible to provide a desirable firmness level. As some non-limiting examples, the elastomeric materials may include, but are not limited to, a styrenic block copolymer and an oil. In some examples, the styrenic block copolymer may comprise a Styrene-Ethylene-Ethylene/Propylene-Styrene (SEEPS) thermoplastic elastomer. In terms of structure, SEEPS may be a series of hydrogenated styrenic block copolymers (HSBC). The copolymers may comprise hard base blocks of styrene and a soft block based on diene, which may have a wide range of hardness.

In some examples, the oil may be a white oil. White oils are highly refined mineral oils that may include saturated aliphatic and alicyclic nonpolar hydrocarbons. White oil may be hydrophobic, colorless, tasteless, odorless, and may not change color over time. The mineral oil may have a kinematic viscosity of about 10 cSt to about 110 cSt at 40° C. (e.g., 10 cSt to 15 cSt, or greater than about 20 cSt, or greater than about 100 cSt). For example, the mineral oil may have a kinematic viscosity of about 10 cSt, 15 cSt, 20 cSt, 25 cSt, 30 cSt, 35 cSt, 40 cSt, 45 cSt, 50 cSt, 55 cSt, 60 cSt, 65 cSt, 70 cSt, 75 cSt, 80 cSt, 85 cSt, 90 cSt, 95 cSt, 100 cSt, 105 cSt, or 110 cSt.

A blend of white oil and SEEPS may provide for a cushioning member having a wide range of processing conditions and compression strengths. In some examples, the elastomeric material may further comprise additives to aid in processing or improve performance of the molded part.

In some examples, a ratio of the styrenic block copolymer to the oil may be from 20:80 to 40:60. For example, the ratio may be about 20:80, 25:75, 30:70, 35:65, or 40:60. Optionally, other suitable materials as desired may be included. For example, additives such as polypropylene and/or colorants may be added to the SEEPS-based composition. In some examples, polypropylene may be present in an amount of up to about 2 wt. %, 5 wt. %, 10 wt. %, or more. For example, polypropylene may be present in an amount of 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, or 10 wt. %. In some examples, a cushioning member may be substantially free of polypropylene. In some examples, an antioxidant or other additives (e.g., colorants) may be present in an amount of up to about 0.1 wt. %, 0.5 wt. 00 or 1 wt. %, or more. In some examples, a cushioning member may be substantially free of an antioxidant or other additives.

In some examples, an anti-tack agent may be applied to a cushioning member upon removal from the injection mold. The anti-tack agent may prevent the walls of the cushioning member from adhering to one another. The anti-tack agent may be a powder. The anti-tack agent may comprise a mineral-based material such as CaCO₃ or talc.

In some examples, the elastomeric material may be compounded to produce a pellet or other particle suitable to feed an injection molding machine. Compounding may be performed using a twin screw extruder and pelletizer. The screw design may include various zones to fully mix the components of the elastomeric material. For example, the screw design may include varied spacing to adjust the pressure in the extruder or may include a kneading zone to provide adequate shear for mixing. In some examples, the pelletizer may include a water bath or underwater pelletizer.

In some examples, the formulation for the elastomeric material may adjusted to provide for high efficiency in both compounding and injection molding processes. Various melt temperatures and viscosity ranges may be considered. For example, a lower viscosity material may be easier to compound, but may be more difficult to process during injection molding.

The response curve of the cushioning member may be tailored by controlling one or more of a material used, the shape of the cushioning member, combinations thereof, or other characteristics as desired. In some embodiments, the ratio of components and/or the chemistry of the components may be modified to adjust the firmness and the support provided by the cushioning member. In some embodiments, the elastomeric material forming the cushioning member may optionally have a hardness of from 10 Shore 00 to 80 Shore 00, inclusive. For example, the elastomeric material may have a hardness of 10, 15, 20, 25, 30, 35, 40, 45, 50, 55, 60, 65, 70, 75, or 80 Shore 00.

The cushioning members described herein may be used independently or with various systems or assemblies as desired, including but not limited to mattress assemblies. The systems may include any number of cushioning members as desired. A mattress assembly may comprise a system of cushioning members comprising an elastomeric material, one or more layers of foam, and optionally, a coil layer.

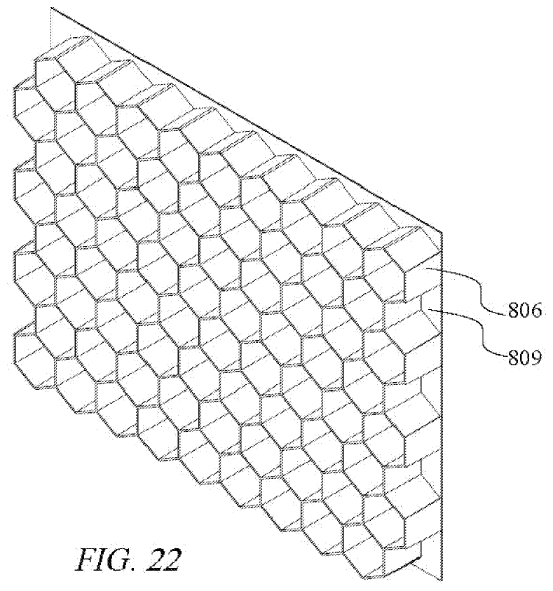

In some examples, a cushioning member may have a backing material connected to the top or bottom face of the member. As shown in FIG. 22, the backing material 809 may be substantially perpendicular to the walls of the cushioning member 806. The backing material may be connected to the cushioning member by adhesive, heat welding or other thermal bond, mechanical connection, or other means known to those skilled in the art and may form an insulator layer. In some examples, the cushioning member may soften if heated to adhere to the backing material. In some examples, the elastomeric material of the cushioning member may not penetrate or otherwise pass through the backing material when the cushioning member is connected to the backing material. The backing material may be a non-woven cloth. The non-woven cloth may comprise a polyester substrate and/or polyester yarn. In some examples, the backing material may be scrim.

Mattress assemblies and upholstered furniture may include cushioning having various levels of support to provide increased comfort to the user. For example, a lumbar region of a mattress assembly may have a different firmness level than that of the head or foot region. In some conventional mattress, an abrupt transition in firmness levels may be noticeable and undesirable to the user. By interlocking cushioning members with different properties as shown in FIG. 17, a gradient or blended area can be created at the intersection of the members and an abrupt transition can be avoided. A blended transition using the system described herein may provide for a more desirable experience by the user by having the cushioning members overlap and provide a smooth transition with blended support. The systems comprising cushioning members described herein may provide other benefits and advantages, and the aforementioned listing should not be considered limiting.

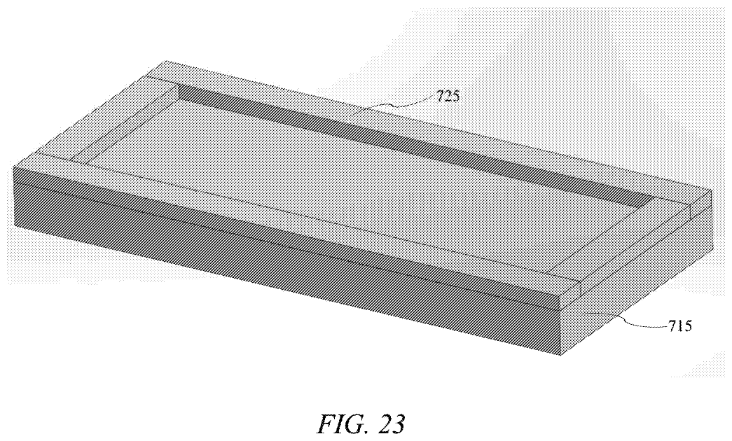

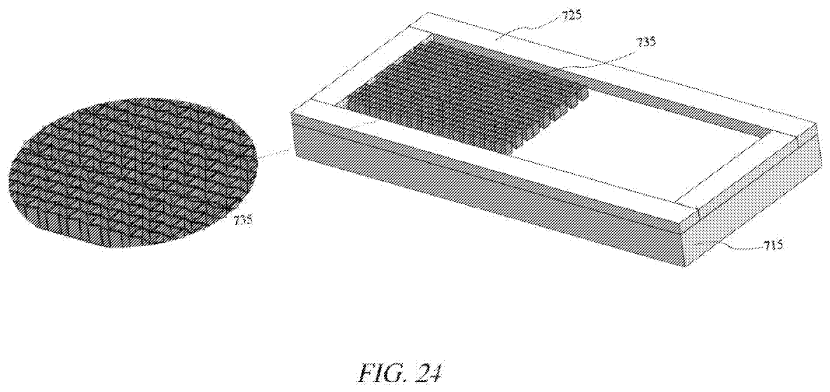

FIG. 23 illustrates one example of a support base for a mattress assembly. FIG. 24 illustrates examples of a mattress assembly with a support base and a cushioning system. A support base 715 comprising foam or other material may be used as a support layer in a mattress assembly. The support base 715 may be 2 to 8 inches in height. For example, the support base 715 height may be 2 in, 2.5 in, 3 in, 3.5 in, 4 in, 4.5 in, 5 in, 5.5 in, 6 in, 6.5 in, 7 in, 7.5 in, or 8 in. A cushioning member system 735 may be placed directly on the support base 715, where the cushioning member system 735 may have a height of 1 to 5 inches. For example, the cushioning member system 735 height may be 1 in, 1.5 in, 2 in, 2.5 in, 3 in, 3.5 in, 4 in, 4.5 in, or 5 in. In some examples, foam rails 725 may be added on top of the support base 715 along the perimeter of the support base 715 to create a tub or basin to hold the cushioning member system 735. The height of the foam rails may be substantially the same as the height of the cushioning member system. Although bowtie shaped members are shown in FIG. 24, other member shapes may be contemplated, including but not limited to, square grid, rectangular grid, rectangular running bond, hexagonal, auxetic, circular, among others. The mattress assembly may include additional layers of material above or below the support base as desired.

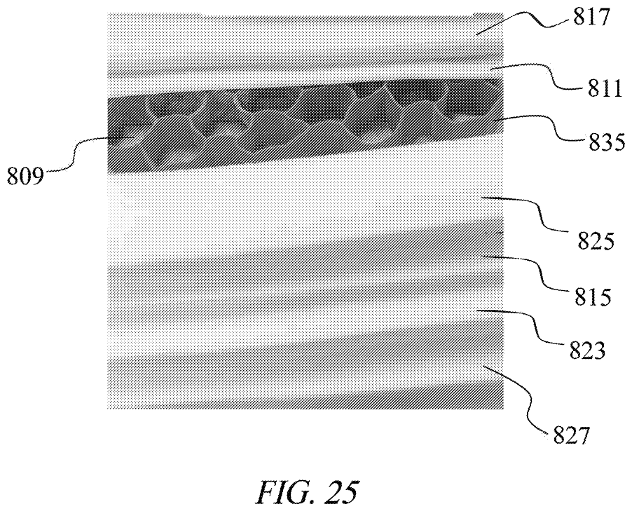

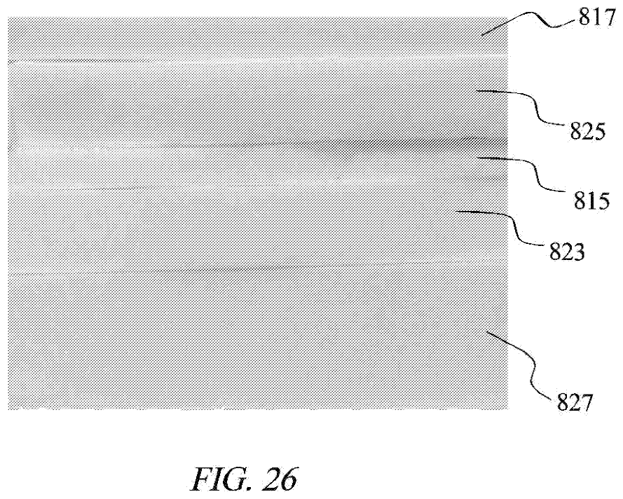

In some examples, a mattress assembly may comprise multiple support layers. As shown in FIGS. 25 and 26, one example of a mattress assembly may comprise a base layer 827, a first foam layer 823, a support base 815, foam rails 825, and upper foam layer 817. A cushioning member system 835 with backing material 809 may be adjacent to the foam rails 825 such that the top of the cushioning member system 835 and top of the foam rails 825 are coplanar. Insulator layer 811 may be located between the cushioning member system 835 and upper foam layer 817.

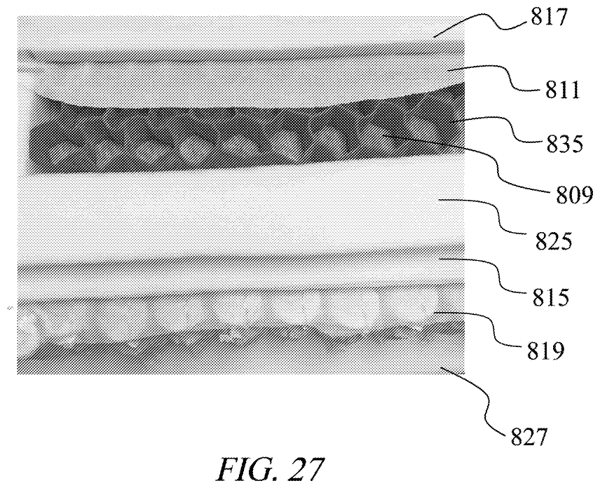

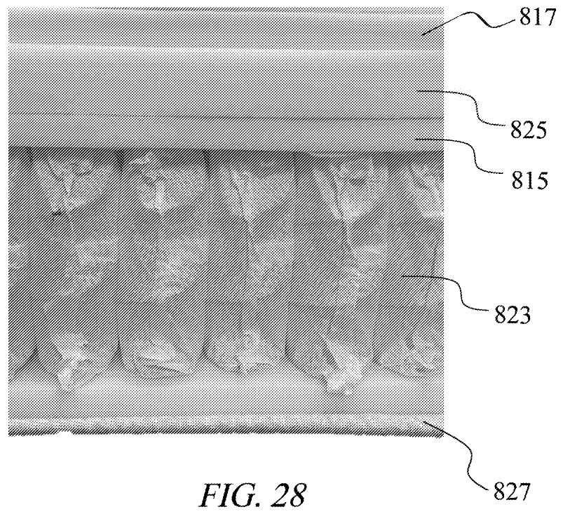

In some examples, a support layer may comprise a coil layer. In some examples, the base layer with cushioning member system may be placed upon a coil layer. The coil layer may be 6 to 8 inches in height. The coils may be individually pocketed and may have varying size and/or spring strength along the perimeter of the coil layer. As shown in FIGS. 27 and 28, one example of a mattress assembly may comprise a base layer 827, a coil layer 819, a support base 815, foam rails 825, and upper foam layer 817. A cushioning member system 835 with backing material 809 may be adjacent to the foam rails 825 such that the top of the cushioning member system 835 and top of the foam rails 825 are coplanar. Insulator layer 811 may be located between the cushioning member system 835 and upper foam layer 817.

One or more upper foam layers or a pillow top surface may be placed upon the cushioning member system. The upper foam layer may be 1 to 4 inches in height. In the mattress assemblies described herein, the cushioning member systems may be within the structure of the assembly as a support layer. A textile cover system may surround the mattress assembly. An FRC sock may be placed between the textile cover and the support layers of the mattress assembly.

In some examples, the support layer may comprise a basin such that the foam rails are integrated into the support layer. In some examples, a second tub or basin may be included in the mattress assembly. The second basin may be placed beneath the coil layer and the coil layer may be placed within the second basin.

The foam layer may be a unity structure. In some examples, the foam layer may include zones or cutouts to modify the properties of the assembly to be more or less firm. In some examples, a removable and/or reversible pillow top may be included.

The base layer may be a unity structure or may be an assembled structure with incorporated side rails. The side rails may be up to 12 inches in width. For example, the width of the side rails may be up to 3 in, 3.5 in, 4 in, 4.5 in, 5 in, 5.5 in, 6 in, 6.5 in, 7 in, 7.5 in, 8 in, 8.5 in, 9 in, 9.5 in, 10 in, 10.5 in, 11 in, 11.5 in, or 12 in.

The interlocking cushioning members may be modular with a substantially square or rectangular shape sized to provide for an even number of members for various sizes of mattress assemblies. The interlocking cushioning member system may comprise members having different stiffness or strength properties and may be arranged to provide a mattress assembly with different support zones, e.g., lumbar region, head or foot regions, or edge regions. The modular aspect may reduce cost and complexity for manufacturing of mattress assemblies or other cushioned products. In some examples, a foam rail may be placed substantially in the center of a mattress assembly to provide for separation of the sides of the mattress assembly for two sleep partners.

In some examples, an insulator layer may be placed over the top face of the cushioning grid to prevent an adjacent foam layer from entering the cavities of the cushioning members. In some examples, a cushioning member may have a backing material connected to bottom face of the member and an insulator layer over a top face, where the backing material and insulator layers are substantially perpendicular to the walls of the cushioning member. The insulator layer may be connected to the cushioning member by adhesive, heat welding or other thermal bond, mechanical connection, or other means known to those skilled in the art. In some examples, insulator layer may be connected to a foam rail by adhesive, heat welding or other thermal bond, mechanical connection, or other means known to those skilled in the art. In some examples, the cushioning member system is not connected to the insulator layer and can move independently of the insulator layer. The insulator layer may be a stretch knit cloth. The stretch knit cloth may comprise a polyester yarn. In some examples, the assembly may be free of an insulator layer between the foam layer and the cushioning members.

In certain examples, a foam layer adjacent to the cushioning member system may include a convoluted foam with protrusions of a shape and size to be complementary to the cushioning member system. The protrusions may be placed within the cavities of the cushioning member system. For example, a convoluted foam may have hexagonal protrusions with a profile complementary to a hex cavity cushioning member system. In such assemblies, the adjacent foam layer and the cushioning member system may optionally be permanently bonded or adhered to one another. In some examples, the upper foam layer, the support base, or both may comprise a convoluted foam.

In certain examples, the support base and the cushioning member system may not be permanently bonded or adhered to one another. In such examples, at least a portion of the cushioning member system may be interchangeable to customize a strength or stiffness of the mattress assembly by inserting different cushioning members with more or less stiffness. For example, a user who has experienced a life change circumstance such as pregnancy, injury or illness, may desire a mattress assembly with more or less stiffness to provide additional comfort. In such cases, the stiffness may be customized by exchanging the cushioning members within the cushioning member system with others to provide a softer or firmer experience. Similarly, a firmness and support level of a mattress assembly may be modified and updated as needed to accommodate changing firmness and support levels for a growing child.

In some cases, the layers of the mattress assembly may be connected to one another using an adhesive, thermal bond, mechanical connection, or other means known to those skilled in the art. The connection of the layers may be permanent or may be semi-permanent to allow for changing portion of the assembly to adjust the properties of the mattress assembly.

Mattress assemblies may include cushioning zones or regions having various levels of support to provide increased comfort to the user. For example, a lumbar region of a mattress assembly may have a different firmness level than that of the head or foot region. In some conventional mattress, an abrupt transition in firmness levels may be noticeable and undesirable to the user. A blended transition using the system described herein may provide for a more desirable experience by the user by having the cushioning members overlap and provide a smooth transition with blended support.

The cushioning member systems may include cavity shapes and patterns that are symmetric both vertically and horizontally when observed from above. Other cavity shapes and patterns may be symmetric in only one direction, vertical or horizontal, when observed from above. The response of the mattress assembly to lateral movement may be impacted by the symmetry of the cushioning member patterns. For example, a user may feel lower resistance when rolling side to side compared to up and down the assembly or a user may experience less lateral movement from movement from a sleep partner.

In some examples, the mattress assembly may enhance the microclimate experienced by the user. The conditions experienced by a user may be referred to as a microclimate and include parameters such as airflow, temperature, and humidity. In some examples, the microclimate control properties of the mattress assemblies described herein may be improved over conventional mattress assemblies. In some examples, the open cavity structure of the cushioning assembly may allow for air to move freely and allow heat to better dissipate.

In some examples, additional layers may be included to direct airflow within the mattress assembly and enhance the microclimate experienced by the user. Air flow may be directed away from the user using one or more layers that provide a bellows effect. For example, a nonwoven scrim layer that includes small holes may be used in combination with a second nonwoven layer to direct airflow within the assembly when the cushioning member system is compressed. In some examples, holes may be punched in the side rails to provide a flow path for air to flow from or exchange with the mattress assembly. In one non-limiting example, the combination of nonwoven layers with cushioning member system may provide for air to be pumped downward away from the user when the user rolls over and enhance the microclimate experienced by the user. The multiple layers may include nonwoven materials, materials with holes punched or melted, or a spacer fabric. In some examples, inclusion of reticulated foam may provide for increased airflow. Airflow may be directed toward the user from the side or bottom of the mattress assembly, directed away from the user to bottom or side of the mattress assembly, exchanged within the mattress assembly between the bottom or sides of the mattress assembly, or combinations thereof. The assemblies and systems comprising cushioning members described herein may provide other benefits and advantages, and the aforementioned listing should not be considered limiting.

Testing of the mattress assemblies and components described herein may be conducted according to ASTM D412-16 (Standard Test Methods for Vulcanized Rubber and Thermoplastic Elastomers-Tension), ASTM D3453-20 (Standard Specification for Flexible Cellular Materials-Urethane for Furniture and Automotive Cushioning, Bedding, and Similar Applications), and ASTM F1566-14 (2021)(Standard Test Methods for Evaluation of Innersprings, Boxsprings, Mattresses or Mattress Sets).

Also described herein are methods of making a cushioning member. A method of making a cushioning member may comprise feeding the elastomeric material and optional additives to an injection molding system, heating the material to a form a molten mixture, transferring the molten mixture into an injection mold to form the cushioning member, and ejecting the cushioning member from the mold. In some examples, the method may further comprise contacting the cushioning member with an anti-tack agent. In some examples, the cushioning member may be cooled prior to ejecting. In some examples, ejector pins may be used to aid in ejecting the cushioning member. In some examples, the feedstock may be in pellet or particle form. In some examples, the method may further comprise compounding the elastomeric material to produce a pellet or other particle prior to feeding the material to the injection molding system. Compounding may be performed using a twin screw extruder and pelletizer. The screw design may include various zones to fully mix the components of the elastomeric material. In some examples, the pelletizer may include a water bath or underwater pelletizer.

Also described herein are methods of making a mattress assembly. A method of making a mattress assembly may comprise placing an elastomeric cushioning member system over at least a portion of a base support layer and placing a foam layer over the elastomeric cushioning member system. The method may further comprise placing support rails over at least a portion of the base support layer, where the support rails are adjacent to the elastomeric cushioning member system and positioned at a perimeter of the base support layer. Optionally, one or more support layers may be positioned above and/or below the base support layer and elastomeric cushioning member system. In some examples, a support layer may comprise a coil system. The coil system may be positioned below the base support layer and elastomeric cushioning member system. In some examples, a pillow top may be placed on top of an upper foam layer. In some examples, one or more insulating layers may be placed within the mattress assembly. The method may further comprise connecting a backing material to an elastomeric cushioning member by an adhesive, heat welding or other thermal bond, mechanical connection, or other means known to those skilled in the art. The method may further comprise arranging a plurality of elastomeric cushioning members to interlock with the projections and recesses of an adjacent cushioning member to form a cushioning grid. The cushioning members may be interlocked in a co-planar arrangement. The support layers may be secured by an adhesive, heat welding or other thermal bond, mechanical connection, or other means known to those skilled in the art.

As used herein, the meaning of “a,” “an,” or “the” includes singular and plural references unless the context clearly dictates otherwise.

As used herein, the modifier “about” is intended to include the described term without the word “about” (e.g., “about 10” is intended to include “10”).

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

### EXAMPLES

The following examples will serve to further illustrate the present invention without, however, constituting any limitation thereof. On the contrary, it is to be clearly understood that resort may be had to various embodiments, modifications, and equivalents thereof which, after reading the description herein, may suggest themselves to those of ordinary skill in the art without departing from the spirit of the invention.

Samples of various formulations were prepared and tested for physical properties as shown in Table 1.

TABLE 1

| | Ex. 1 | Ex. 2 | Ex. 3 |
|---|---|---|---|
| Tensile at break (MPa) | 2.74 | 2.14 | 3.58 |
| Elongation at break (%) | >2643 | 1291 | 1200 |
| Hardness, Shore 00 | 42.2 | 59.3 | 77.3 |
| Polypropylene Additive | no | yes | yes |

### Illustrative Embodiments of Suitable Systems, Articles, Assemblies, and Methods

As used below, any reference to systems, articles, or methods is understood as a reference to each of those systems, articles, or methods disjunctively (e.g., “Illustrative embodiment 1-4 is understood as illustrative embodiment 1, 2, 3, or 4.”).

Illustrative embodiment 1 is a cushioning member comprising: a top end; a bottom end; and a plurality of walls extending from the top end to the bottom end and defining a plurality of cavities, wherein the plurality of walls comprise an elastomeric material, and wherein between the top end and the bottom end, each wall comprises at least a first compression region and a second compression region.

Illustrative embodiment 2 is the cushioning member of any preceding or subsequent illustrative embodiment, wherein a height of the first compression region between the top end and the bottom end is different from a height of the second compression region between the top end and the bottom end for at least one wall of the plurality of walls.

Illustrative embodiment 3 is the cushioning member of any preceding or subsequent illustrative embodiment, wherein a height of the first compression region between the top end and the bottom end is the same as a height of the second compression region between the top end and the bottom end for at least one wall of the plurality of walls.

Illustrative embodiment 4 is the cushioning member of any preceding or subsequent illustrative embodiment, wherein a maximum wall thickness of each wall of the plurality of walls is between the top end and the bottom end.

Illustrative embodiment 5 is the cushioning member of any preceding or subsequent illustrative embodiment, wherein each wall of the plurality of walls comprises a parting line between the top end and the bottom end, and wherein the parting line comprises the maximum wall thickness.

Illustrative embodiment 6 is the cushioning member of any preceding or subsequent illustrative embodiment, wherein each wall of the plurality of walls comprises a maximum wall thickness, and wherein the maximum wall thickness of a first wall of the plurality of walls is different from the maximum wall thickness of a second wall of the plurality of walls.

Illustrative embodiment 7 is the cushioning member of any preceding or subsequent illustrative embodiment, wherein the first wall is a perimeter wall and the second wall is an internal wall, and wherein the maximum wall thickness of the first wall is different than the maximum wall thickness of the second wall.

Illustrative embodiment 8 is the cushioning member of any preceding or subsequent illustrative embodiment, wherein at least one wall of the plurality of walls comprises a variable wall thickness between the top end and the bottom end.

Illustrative embodiment 9 is the cushioning member of any preceding or subsequent illustrative embodiment, wherein each wall of the plurality of walls comprises a parting line between the top end and the bottom end, and wherein the first compression region is defined between the parting line and the top end and the second compression region is defined between the parting line and the bottom end for each wall.

Illustrative embodiment 10 is the cushioning member of any preceding or subsequent illustrative embodiment, wherein a distance between the parting line and the top end is different from a distance between the parting line and the bottom end for at least one wall of the plurality of walls.

Illustrative embodiment 11 is the cushioning member of any preceding or subsequent illustrative embodiment, wherein the plurality of walls comprises a first wall and a second wall, wherein the parting line of the first wall is a first distance from the top end, and wherein the parting line of the second line is a second distance from the top end that is different from the first distance.

Illustrative embodiment 12 is the cushioning member of any preceding or subsequent illustrative embodiment, wherein the cushioning member is injection molded.

Illustrative embodiment 13 is the cushioning member of any preceding or subsequent illustrative embodiment, wherein the elastomeric material comprises a styrenic block copolymer and an oil.

Illustrative embodiment 14 is the cushioning member of any preceding or subsequent illustrative embodiment, wherein a shape of each cavity of the plurality of cavities is the same.

Illustrative embodiment 15 is the cushioning member of any preceding or subsequent illustrative embodiment, wherein each cavity comprises a hexagonal shape, a rectangular shape, a bowtie shape, or an auxetic shape.

Illustrative embodiment 16 is the cushioning member of any preceding or subsequent illustrative embodiment, wherein the plurality of cavities comprises a first cavity and a second cavity, and wherein a shape of the first cavity is different from a shape of the second cavity.

Illustrative embodiment 17 is the cushioning member of any preceding or subsequent illustrative embodiment, wherein a wall thickness of each wall of the plurality of walls is from 0.1 inches to 0.25 inches, inclusive.

Illustrative embodiment 18 is the cushioning member of any preceding or subsequent illustrative embodiment, wherein a distance from the top end to the bottom end is a wall height, and wherein the wall height is from 0.5 inches to 5 inches, inclusive.

Illustrative embodiment 19 is the cushioning member of any preceding or subsequent illustrative embodiment, wherein the elastomeric material comprises a hardness from 10 Shore 00 to 80 Shore 00, inclusive.

Illustrative embodiment 20 is the cushioning member of any preceding or subsequent illustrative embodiment, wherein at least some of the walls of the plurality of walls are perimeter walls define a mating profile, and wherein the mating profile is configured to engage with a complimentary mating profile of another cushioning member.

Illustrative embodiment 21 is the cushioning member of any preceding or subsequent illustrative embodiment, wherein each cavity comprises a vertical axis, and wherein the first compression region or the second compression region of at least one wall of the plurality of walls extends at an angle relative to the vertical axis.

Illustrative embodiment 22 is the cushioning member of any preceding or subsequent illustrative embodiment, wherein both the first compression region and the second compression region extend at angles relative to the vertical axis.

Illustrative embodiment 23 is the cushioning member of any preceding or subsequent illustrative embodiment, wherein the angle of the first compression region is different from the angle of the second compression region.

Illustrative embodiment 24 is the cushioning member of any preceding or subsequent illustrative embodiment, wherein the cushioning member is compressible at least in a vertical direction.

Illustrative embodiment 25 is the cushioning member of any preceding or subsequent illustrative embodiment, wherein the styrenic block copolymer comprises as a Styrene-Ethylene-Ethylene/Propylene-Styrene (SEEPS) thermoplastic elastomer.

Illustrative embodiment 26 is the cushioning member of any preceding or subsequent illustrative embodiment, wherein the oil comprises mineral oil, optionally a white mineral oil.

Illustrative embodiment 27 is the cushioning member of any preceding or subsequent illustrative embodiment, wherein the mineral oil has a kinematic viscosity of about 10 cSt to about 110 cSt at 40° C.

Illustrative embodiment 28 is the cushioning member of any preceding or subsequent illustrative embodiment, further comprising polypropylene.

Illustrative embodiment 29 is the cushioning member of any preceding or subsequent illustrative embodiment, wherein polypropylene is present in an amount up to about 10 wt. %.

Illustrative embodiment 30 is the cushioning member of any preceding or subsequent illustrative embodiment, wherein a ratio of the styrenic block copolymer to the oil is from 20:80 to 40:60.

Illustrative embodiment 31 a cushioning member comprising a plurality of walls comprising an elastomeric material, wherein the plurality of walls define a plurality of cavities, and wherein each wall of the plurality of walls comprises a parting line.

Illustrative embodiment 32 is a cushioning member comprising a plurality of elastomeric interconnected walls forming various shapes, wherein the walls viewed from above create repeating patterns, and wherein the walls have a wall thickness.

Illustrative embodiment 33 is a system comprising a plurality of cushioning members comprising an elastomeric material and a plurality of walls defining a plurality of cavities, and wherein each wall of the plurality of walls comprises a parting line, and wherein each member comprises a mating profile configured to interlock with a cushioning member having a complementary mating profile.

Illustrative embodiment 34 is a system comprising a plurality of cushioning members comprising elastomeric interconnected walls forming various shapes, wherein the walls viewed from above create repeating patterns, wherein the walls have a wall thickness and wherein each member comprises a mating profile configured to interlock with a cushioning member having a complementary mating profile.

Illustrative embodiment 35 is a cushioning system comprising a plurality of cushioning members comprising an elastomeric material, wherein each cushioning member comprises a top end, bottom end, and a plurality of walls extending from the top end to the bottom end and defining a plurality of cavities, and wherein each cushioning member is substantially planar with a mating profile configured to engage with a complimentary mating profile of a second cushioning member.

Illustrative embodiment 36 is the cushioning system of any preceding or subsequent illustrative embodiment, wherein the mating profile comprises projections and recesses configured to interlock with projections and recesses of the second cushioning member to form a cushioning grid.

Illustrative embodiment 37 is the cushioning system of any preceding or subsequent illustrative embodiment, wherein at least one wall of the plurality of walls comprises a variable wall thickness between the top end and the bottom end.

Illustrative embodiment 38 is the cushioning system of any preceding or subsequent illustrative embodiment, wherein each cushioning member is injection molded.

Illustrative embodiment 39 is the cushioning system of any preceding or subsequent illustrative embodiment, wherein the cushioning member comprises an elastomeric material comprising a styrenic block copolymer and an oil.

Illustrative embodiment 40 is the cushioning system of any preceding or subsequent illustrative embodiment, wherein the styrenic block copolymer comprises as a Styrene-Ethylene-Ethylene/Propylene-Styrene (SEEPS) thermoplastic elastomer.

Illustrative embodiment 41 is the cushioning system of any preceding or subsequent illustrative embodiment, wherein the oil comprises mineral oil.

Illustrative embodiment 42 is the cushioning system of any preceding or subsequent illustrative embodiment, wherein the oil has a kinematic viscosity of about 10 cSt to about 110 cSt at 40° C.

Illustrative embodiment 43 is the cushioning system of any preceding or subsequent illustrative embodiment, wherein a ratio of the styrenic block copolymer to the oil is from 20:80 to 40:60.

Illustrative embodiment 44 is the cushioning system of any preceding or subsequent illustrative embodiment, wherein the elastomeric material comprises a hardness from 10 Shore 00 to 80 Shore 00.

Illustrative embodiment 45 is the cushioning system of any preceding or subsequent illustrative embodiment, wherein the cushioning member further comprises polypropylene.

Illustrative embodiment 46 is the cushioning system of any preceding or subsequent illustrative embodiment, wherein the polypropylene is present in an amount up to about 10 wt. %.

Illustrative embodiment 47 is the cushioning system of any preceding or subsequent illustrative embodiment, wherein each cavity comprises a hexagonal shape, a rectangular shape, a bowtie shape, or an auxetic shape.

Illustrative embodiment 48 is the cushioning system of any preceding or subsequent illustrative embodiment, wherein a wall thickness of each wall of the plurality of walls is from 0.1 inches to 0.25 inches, inclusive.

Illustrative embodiment 49 is the cushioning system of any preceding or subsequent illustrative embodiment, wherein a distance from the top end to the bottom end is a wall height, and wherein the wall height is from 0.5 inches to 5 inches, inclusive.

Illustrative embodiment 50 is the cushioning system of any preceding or subsequent illustrative embodiment, wherein each wall comprises at least a first compression region and a second compression region.

Illustrative embodiment 51 is the cushioning system of any preceding or subsequent illustrative embodiment, wherein a height of the first compression region between the top end and the bottom end is different from a height of the second compression region between the top end and the bottom end for at least one wall of the plurality of walls.

Illustrative embodiment 52 is the cushioning system of any preceding illustrative embodiment, wherein each wall of the plurality of walls comprises a parting line between the top end and the bottom end, and wherein the parting line comprises the maximum wall thickness.

Illustrative embodiment 53 is a mattress assembly comprising: a base layer; at least one foam layer; and a cushioning member system located between the base layer and the at least one foam layer, wherein the cushioning member system comprises a plurality of cushioning members comprising an elastomeric material.

Illustrative embodiment 54 is the mattress assembly of any preceding or subsequent illustrative embodiment, wherein each cushioning member comprises atop end, bottom end, and a plurality of walls extending from the top end to the bottom end and defining a plurality of cavities.

Illustrative embodiment 55 is the mattress assembly of any preceding or subsequent illustrative embodiment, wherein each cavity comprises a hexagonal shape, a rectangular shape, a bowtie shape, or an auxetic shape.

Illustrative embodiment 56 is the mattress assembly of any preceding or subsequent illustrative embodiment, wherein each wall comprises at least a first compression region and a second compression region, and wherein each cushioning member is substantially planar with a mating profile configured to engage with a complimentary mating profile of a second cushioning member.

Illustrative embodiment 57 is the mattress assembly of any preceding or subsequent illustrative embodiment, wherein at least one wall of the plurality of walls comprises a variable wall thickness between the top end and the bottom end.

Illustrative embodiment 58 is the mattress assembly of any preceding or subsequent illustrative embodiment, wherein the base layer comprises foam.

Illustrative embodiment 59 is the mattress assembly of any preceding or subsequent illustrative embodiment, wherein the base layer further comprises side rails.

Illustrative embodiment 60 is the mattress assembly of any preceding or subsequent illustrative embodiment, further comprising a coil layer.

Illustrative embodiment 61 is the mattress assembly of any preceding or subsequent illustrative embodiment, wherein the cushioning member is injection molded.

Illustrative embodiment 62 is the mattress assembly of any preceding or subsequent illustrative embodiment, wherein the elastomeric material comprises a styrenic block copolymer and an oil.

Illustrative embodiment 63 is the mattress assembly of any preceding illustrative embodiment, wherein the elastomeric material comprises a hardness from 10 Shore 00 to 80 Shore 00, inclusive.

Illustrative embodiment 64 is a mattress assembly comprising a base layer; at least one foam layer; and the cushioning system of any preceding illustrative embodiment.

Illustrative embodiment 65 is an article comprising the cushioning system of any preceding illustrative embodiment.

Illustrative embodiment 66 is a method of making a cushioning member of any preceding illustrative embodiment, wherein the method comprises heating an elastomeric material and injecting the elastomeric material into a mold to form the cushioning member.

Illustrative embodiment 67 is a method of making a mattress assembly of any preceding illustrative embodiment, wherein the method comprises applying an adhesive to one or more support layers to form a mattress assembly.

The above-described aspects are merely possible examples of implementations, merely set forth for a clear understanding of the principles of the present disclosure. Many variations and modifications can be made to the above-described example(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

1. A cushioning system comprising:
a plurality of cushioning members comprising an elastomeric material,
wherein each cushioning member comprises a top end, bottom end, and a plurality of walls extending from the top end to the bottom end and defining a plurality of cavities, and
wherein each cushioning member is substantially planar with a mating profile configured to engage with a complimentary mating profile of a second cushioning member.

2. The system of claim 1, wherein the mating profile comprises projections and recesses configured to interlock with projections and recesses of the second cushioning member to form a cushioning grid.

3. The system of claim 1, wherein at least one wall of the plurality of walls comprises a variable wall thickness between the top end and the bottom end.

4. The system of claim 1, wherein each cushioning member is injection molded.

5. The system of claim 1, wherein the cushioning member comprises an elastomeric material comprising a styrenic block copolymer and an oil.

6. The system of claim 5, wherein the styrenic block copolymer comprises as a Styrene-Ethylene-Ethylene/Propylene-Styrene (SEEPS) thermoplastic elastomer.

7. The system of claim 5, wherein the oil comprises mineral oil.

8. The system of claim 5, wherein the oil has a kinematic viscosity of about 10 cSt to about 110 cSt at 40° C.

9. The system of claim 5, wherein a ratio of the styrenic block copolymer to the oil is from 20:80 to 40:60.

10. The system of claim 5, wherein the elastomeric material comprises a hardness from 10 Shore 00 to 80 Shore 00.

11. The system of claim 5, wherein the cushioning member further comprises polypropylene.

12. The system of claim 11, wherein the polypropylene is present in an amount up to about 10 wt. %.

13. The system of claim 1, wherein each cavity comprises a hexagonal shape, a rectangular shape, a bowtie shape, or an auxetic shape.

14. The system of claim 1, wherein a wall thickness of each wall of the plurality of walls is from 0.1 inches to 0.25 inches, inclusive.

15. The system of claim 1, wherein a distance from the top end to the bottom end is a wall height, and wherein the wall height is from 0.5 inches to 5 inches, inclusive.

16. The system of claim 1, wherein each wall comprises at least a first compression region and a second compression region.

17. The system of claim 16, wherein a height of the first compression region between the top end and the bottom end is different from a height of the second compression region between the top end and the bottom end for at least one wall of the plurality of walls.

18. The system of claim 1, wherein each wall of the plurality of walls comprises a parting line between the top end and the bottom end, and wherein the parting line comprises the maximum wall thickness.

19. A mattress assembly comprising:
a support base layer;
at least one foam layer; and
a cushioning member system located between the support base layer and the at least one foam layer,
wherein the cushioning member system comprises a plurality of cushioning members comprising an elastomeric material.

20. The mattress assembly of claim 19, wherein each cushioning member comprises a top end, bottom end, and a plurality of walls extending from the top end to the bottom end and defining a plurality of cavities.

21. The system of claim 20, wherein each cavity comprises a hexagonal shape, a rectangular shape, a bowtie shape, or an auxetic shape.

22. The mattress assembly of claim 20, wherein each wall comprises at least a first compression region and a second compression region, and
wherein each cushioning member is substantially planar with a mating profile configured to engage with a complimentary mating profile of a second cushioning member.

23. The mattress assembly of claim 20, wherein at least one wall of the plurality of walls comprises a variable wall thickness between the top end and the bottom end.

24. The mattress assembly of claim 19, wherein the support base layer comprises foam.

25. The mattress assembly of claim 24, wherein the support base layer further comprises a side rail.

26. The mattress assembly of claim 19, further comprising a coil layer.

27. The mattress assembly of claim 19, wherein the cushioning member is injection molded.

28. The mattress assembly of claim 19, wherein the elastomeric material comprises a styrenic block copolymer and an oil.

29. The mattress assembly of claim 19, wherein the elastomeric material comprises a hardness from 10 Shore 00 to 80 Shore 00, inclusive.

30. A mattress assembly comprising:
a support base layer;
at least one foam layer; and
the cushioning system of claim 1.
